(19) United States
(12) Patent Application Publication
(10) Pub. No.: US 2018/0083379 A1
(43) Pub. Date: Mar. 22, 2018

(54) HERMAPHRODITIC SPACER CONNECTOR

(71) Applicant: Advanced Interconnections Corp., West Warwick, RI (US)

(72) Inventors: Burton J. Fisher, Coventry, RI (US); Glenn Goodman, Harrisville, RI (US)

(21) Appl. No.: 15/707,362

(22) Filed: Sep. 18, 2017

Related U.S. Application Data
(60) Provisional application No. 62/395,546, filed on Sep. 16, 2016.

(51) Int. Cl. H01R 13/28; H01R 13/05; H01R 13/213

(52) U.S. Cl. CPC H01R 13/28; H01R 13/213; H01R 13/052

(57) ABSTRACT

A terminal assembly includes an insulating support member including first and second arrays of apertures, each aperture extending from an upper surface of the insulating support member to an opposite lower surface of the insulating support member. The terminal assembly also includes first and second terminals for providing electrical connections arranged in a configuration corresponding with the first and second arrays of apertures. Each of the first terminals is received within a corresponding aperture of the first array of apertures and has an end with an opening configured to receive one of the first plurality of terminals and an opposite end configured to contact a corresponding electrical contact. Each of the second terminals is received within a corresponding aperture of the second array of apertures and has an end configured to be received within a socket and an opposite end configured to contact a corresponding electrical contact.

### CROSS-REFERENCE TO RELATED APPLICATIONS

This application claims the benefit of U.S. Provisional Application No. 62/395,546 filed Sep. 16, 2016, which is incorporated by herein by reference.

### TECHNICAL FIELD

This invention relates to making electrical connections between electrical devices.

### BACKGROUND

Electrical connection pins are a popular means for connecting two electrical devices. For example, integrated circuit (IC) packages typically possess a number of male electrical connection pins for mounting the IC package an electrical socket on a printed circuit board (PCB). Each of the male electrical connection pins of the IC package is inserted into corresponding female sockets in the electrical socket on the PCB. As technology continues to advance, the size of electrical devices continues to decrease while the number of connections required between electrical devices continues to increase. Consequently, increasing the density of electrical connection terminals for electrically connecting two electrical devices is necessary.

### SUMMARY

The invention relates to a terminal assembly for electrically connecting two electrical devices as described in U.S. Pat. No. 7,419,398, which is incorporated herein in its entirety.

In a general aspect of the invention, a terminal assembly is used to electrically connect electrical devices, the terminal assembly comprising an insulating support member including a first array of apertures and a second array of apertures, each aperture of the first and second arrays extending from an upper surface of the first insulating support member to an opposite lower surface of the insulating support member. The terminal assembly also includes a first plurality of terminals for providing electrical connections arranged in a configuration corresponding with the first array of apertures, each of the first plurality of terminals received within a corresponding aperture of the first array of apertures of the insulating support member and having an end with an opening and an opposite end configured to contact a corresponding electrical contact; and a second plurality of terminals for providing electrical connections arranged in a configuration corresponding with the second array of apertures, each of the second plurality of terminals received within a corresponding aperture of the second array of apertures of the insulating support member and having an end configured to be received within a socket and an opposite end configured to contact a corresponding electrical contact.

Preferred embodiments of this aspect of the invention may include one or more of the following features.

The opposite end of each of the first plurality of terminals and the opposite end of each second plurality of terminals is a pin and a socket, respectively.

The terminal assembly further comprises a plurality of interstitial spaces between the first plurality of terminals and a plurality of interstitial spaces between the second plurality of terminals. The first plurality of terminals and the second plurality of terminals are arranged in a pattern comprising a plurality of columns, each column arranged in an alternating sequence of first plurality of terminals and second plurality of terminals such that each interstitial space between the first plurality of terminals is occupied by one of the second plurality of terminals and each interstitial space between the second plurality of terminals pins is occupied by one of the first plurality of terminals. The pattern includes a plurality of rows, each row arranged in an alternating sequence of first plurality of terminals and second plurality of terminals such that each interstitial space between the first plurality of terminals is occupied by one of the second plurality of terminals and each interstitial space between the second plurality of terminals pins is occupied by one of the first plurality of terminals.

The first array of apertures and the second array of apertures are arranged in a pattern comprising a plurality of columns, each column having an axis, the columns located such that the distance between the axes of adjacent columns is less than a standard diameter of apertures of the first array of apertures. Each column is arranged in an alternating sequence of the first plurality of terminals and the second plurality of terminals. The height of at least one pin of the plurality of pins is different than the height of every other pin.

The insulating support member includes at least one alignment element to align the first plurality of terminals and second plurality of terminals with corresponding electrical contacts on a corresponding terminal assembly. The at least one alignment element comprises at least one alignment guide post disposed through the insulating support member to be received by a corresponding alignment hole in a corresponding terminal assembly. The at least one guide post can provide an electrical connection.

In another aspect of this invention, a method of manufacturing a terminal assembly of the type used to electrically connect electrical devices includes the following steps. A first insulating support member including a first array of apertures and a second array of apertures is provided. Each aperture of the first and second array of apertures extends from an upper surface of the first insulating support member to an opposite lower surface of the insulating support member. A first plurality of terminals is positioned within a corresponding aperture of the first array of apertures of the insulating support member. Each of the first plurality of terminals has an end with an opening and an opposite end configured to contact a corresponding electrical contact. A second plurality of terminals is positioned within a corresponding aperture of the second array of apertures of the insulating support member. Each of the second plurality of terminals has an end configured to be received within a socket and an opposite end configured to contact a corresponding electrical contact.

Preferred embodiments of this method of manufacturing a terminal assembly may include one or more of the following features.

Providing the first insulating support member comprises machining the first and second arrays of apertures in the first support member, each aperture extending from a first surface of the first support member and terminating before reaching an opposite second surface of the first support member. A recess is formed in the opposite second surface of the first support member such that each aperture extends from the first surface of the first support member to a base surface of the recess.

The first plurality of terminals defines a first plurality of interstitial spaces between the first plurality of terminals and the second plurality of terminals defines a second plurality of interstitial spaces between the second plurality of terminals. The first plurality of terminals and the second plurality of terminals are arranged in a pattern comprising a plurality of columns, each column arranged in an alternating sequence of the first plurality of terminals and the second plurality of terminals such that each interstitial space between the first plurality of terminals is occupied by one of the first plurality of terminals pin and each interstitial space between the second plurality of terminals pins is occupied by one of the second plurality of terminals

Among other advantages, a hermaphroditic spacer connector having the structure as well as produced by the method discussed above provides all of the advantages associated with traditional socket/adapter technology (e.g., non-permanent connections) while providing a substantial increase in the density of electrical connections between electrical devices or substrates (e.g., printed circuit boards) having electrical connections.

Furthermore, the hermaphroditic spacer connector provides a user with the option to leave the connectors at the original height or raise it higher if they have board limitations or need to go over something that is already on the printed circuit board. The hermaphroditic spacer connector can be installed or removed by the user at anytime.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exploded, isometric view of an intercoupling component including two hermaphroditic terminal assemblies, an IC package, and a hold-down assembly positioned over a printed circuit board.

FIGS. 2A-2B are cross-sectional side views of a portion of the intercoupling component of FIG. 1.

FIG. 3 is a cross-sectional side view of a portion of an alternative embodiment of an intercoupling component.

FIG. 4 is a cross-sectional side view of an alternate intercoupling component.

FIG. 5 is a perspective view of an insulating support member of the intercoupling component of FIG. 4.

FIG. 6 is an isometric view of a hermaphroditic spacer connector.

FIG. 7 is a side view (partially in cross section) of the hermaphroditic spacer connector of FIG. 6.

FIG. 8 is a side view (partially in cross section) of the hermaphroditic spacer connector of FIG. 1 interposed between two hermaphroditic terminal assemblies of the type shown in FIG. 1.

Like reference symbols in the various drawings indicate like elements.

### DETAILED DESCRIPTION

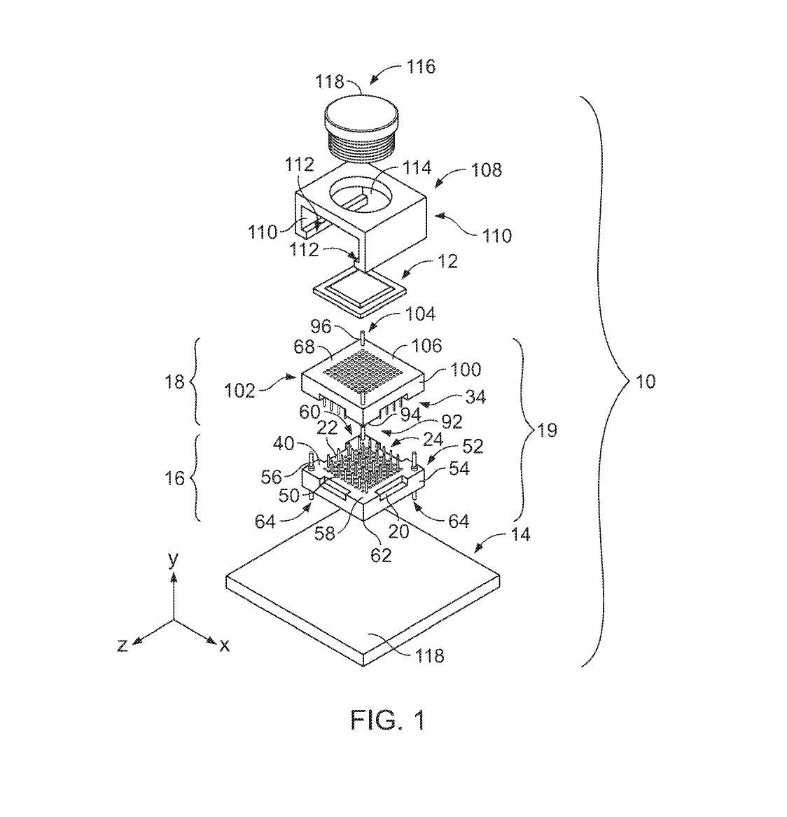

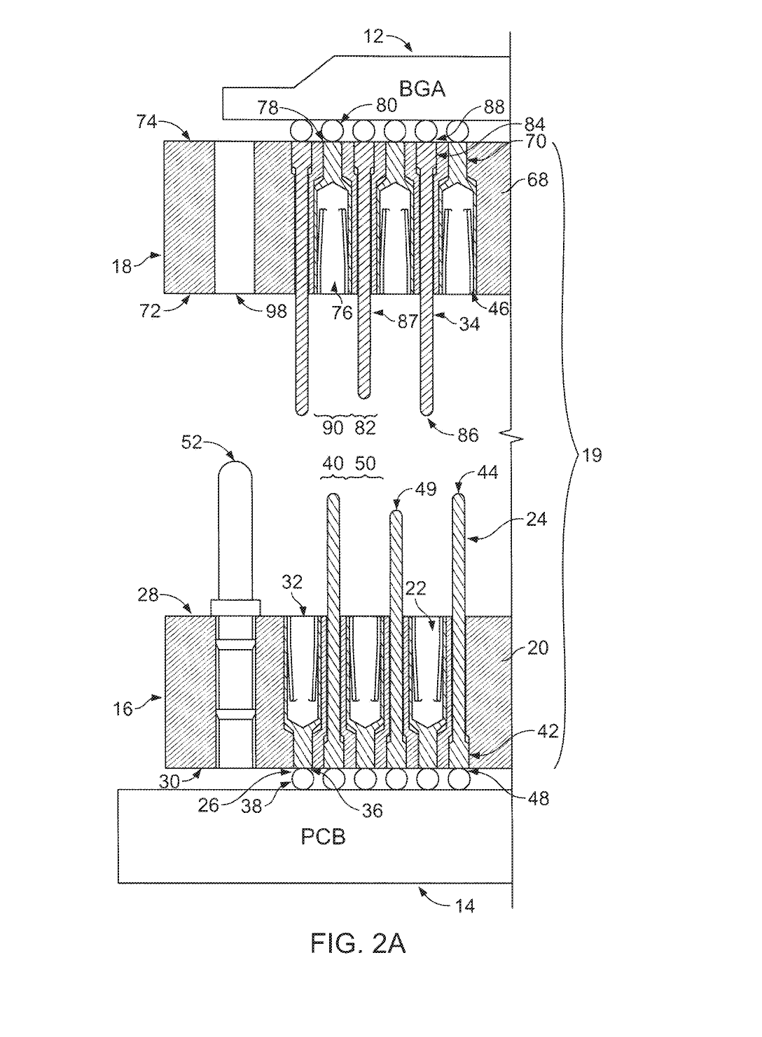

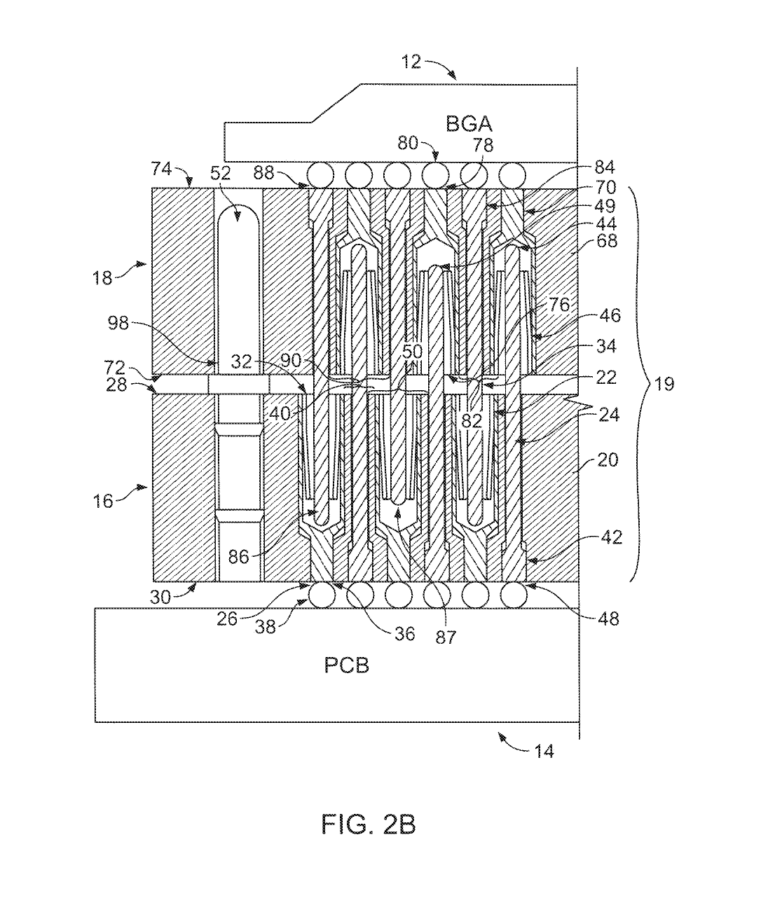

Referring to FIGS. 1, 2A, and 2B, a hermaphroditic socket/adapter assembly 10 for electrically connecting an IC package 12 to a PCB 14 is shown. Hermaphroditic socket/adapter assembly 10, includes a first hermaphroditic terminal assembly 16 and a second hermaphroditic terminal assembly 18 that together comprise an intercoupling component 19.

First hermaphroditic terminal assembly 16 includes an insulating support member 20 for supporting female sockets 22 and male pins 24. Insulating support member 20 includes a first array of apertures 26, extending from the upper surface 28 of insulating support member 20 to the bottom surface 30 of insulating support member 20. Each female socket 22 is received within one aperture 26 of the first array of apertures of the insulating support member 20. Each female socket 22 has a first end 32 configured to receive a corresponding male pin 34 of the second hermaphroditic terminal assembly 18 and a second end 36 attached to a solder ball 38 that establishes an electrical connection with the electrical contact 39 on PCB 14. The female sockets 22 received within the first array of apertures 26 of the insulating support member 20 are arranged such that interstitial spaces 40 exist between the female sockets 22.

Insulating support member 20 also includes a second array of apertures 42, extending from the upper surface 28 of insulating support member 20 to the bottom surface 30 of insulating support member 20. Each male pin 24 is received within one aperture 42 of the second array of apertures of the insulating support member 20. Each male pin has a first end 44 configured to be received within a corresponding female socket 46 of the second hermaphroditic terminal assembly 18 and a second end 48 attached to a solder ball 38 that establishes an electrical connection with electrical contact 39 on PCB 14. In some applications, it may be desirable for at least one male pin 49 to be of a different height than every other male pin 24 where the height of a pin is defined as the length from the first end of the pin 44 to the second end of the pin 48. Varying the height of the pins serves to decrease the force required to insert the first hermaphroditic terminal assembly 16 into a corresponding hermaphroditic terminal assembly. Varying the height of the pins also serves to decrease the force required to extract the first hermaphroditic terminal assembly 16 from a corresponding hermaphroditic terminal assembly into which it has been inserted. The male pins 24 received within the second array of apertures 42 of the insulating support member 20 are arranged such that interstitial spaces 50 exist between the male pins 24. Collectively, the female sockets 22 and the male pins 24 are arranged in a pattern such that the interstitial spaces 40 between the female sockets 22 are occupied by male pins 24, and the interstitial spaces 50 between the male pins 24 are occupied by female sockets 22. It is appreciated that the female sockets 22 and the male pins 24 could be arranged in different patterns.

First hermaphroditic terminal assembly 16 also includes two alignment guide posts 52 located in opposite corners 54, 56 of first hermaphroditic terminal assembly 16 and disposed through the upper surface 28 of the insulating support member 20 and two alignment guide holes 58 located in opposite corners 60, 62 of the upper surface 28 of the insulating support member 20. In addition, first hermaphroditic terminal assembly 16 includes two alignment guide posts 64 located in opposite corners 54, 56 of first hermaphroditic terminal assembly 16 and disposed through the lower surface 30 of the insulating support member 20 and two alignment guide holes (not shown) located in opposite corners 60, 62 of the lower surface 30 of the insulating support member 20.

Second hermaphroditic terminal assembly 18 includes an insulating support member 68 for supporting female sockets 46 and male pins 34. Insulating support member 68 includes a first array of apertures 70, extending from the upper surface 72 of insulating support member 68 to the bottom surface 74 of insulating support member 68. Each female socket 46 is received within one aperture 70 of the first array of apertures of the insulating support member 68. Each female socket 46 has a first end 76 configured to receive a corresponding male pin 24 of the first hermaphroditic terminal assembly 16 and a second end 78 configured to contact a solder ball 80 on IC package 12. The female sockets 46 received within the first array of apertures 70 of the insulating support member 68 are arranged such that interstitial spaces 82 exist between the female sockets 46.

Insulating support member 68 also includes a second array of apertures 84, extending from the upper surface 72 of insulating support member 68 to the bottom surface 74 of insulating support member 68. Each male pin 34 is received within one aperture 84 of the second array of apertures of the insulating support member 68. Each male pin has a first end 86 configured to be received within a corresponding female socket 22 of the first hermaphroditic terminal assembly 16 and a second end 88 configured to contact a corresponding solder ball 80 on IC package 12. In some applications, it may be desirable for at least one male pin 87 to be of a different height than every other male pin 34, where the height of a pin is defined as the length from the first end of the pin 86 to the second end of the pin 88. Varying the height of the pins serves to decrease the force required to insert the second hermaphroditic terminal assembly 18 into a corresponding hermaphroditic terminal assembly. Varying the height of the pins also serves to decrease the force required to extract the second hermaphroditic terminal assembly 18 from a corresponding hermaphroditic terminal assembly into which it has been inserted. The male pins 34 received within the second array of apertures 84 of the insulating support member 68 are arranged such that interstitial spaces 90 exist between the male pins 34. Collectively, the female sockets 46 and the male pins 34 are arranged in a pattern such that the interstitial spaces 82 between the female sockets 46 are occupied by male pins 34, and the interstitial spaces 90 between the male pins 34 are occupied by female sockets 46. It is appreciated that the female sockets 46 and the male pins 34 could be arranged in different patterns.

Second hermaphroditic terminal assembly 18 also includes two alignment guide posts 92 located in opposite corners 94, 96 of second hermaphroditic terminal assembly 18 and disposed through the upper surface 72 of the insulating support member 68 and two alignment guide holes 98 located in opposite corners 100, 102 of the upper surface 72 of the insulating support member 68. In addition, second hermaphroditic terminal assembly 18 includes two alignment guide posts 104 located in opposite corners 94, 96 of second hermaphroditic terminal assembly 18 and disposed through the lower surface 74 of the insulating support member 68 and two alignment guide holes 98 located in opposite corners 100, 102 of the lower surface 74 of the insulating support member 68.

The intercoupling component 19 is used to electrically connect IC package 12 to PCB 14. IC package 12 is secured to the lower surface 74 of insulating support member 68 of the second hermaphroditic terminal assembly 18 such that the solder balls 80 on IC package 12 are brought into contact with the second ends 78 of the female sockets 46 of the second hermaphroditic terminal assembly 18 and the second ends 88 of the male pins 34 of the second hermaphroditic terminal assembly 18. The alignment guide posts 104 disposed through the lower surface 74 the insulating support member 68 of the second terminal assembly can be used to properly align the solder balls 80 on IC package 12 with the second ends 78 of the female sockets 46 of the second hermaphroditic terminal assembly 18 and the second ends 88 of the male pins 34 of the second hermaphroditic terminal assembly 18. It is appreciated that other alignment elements could be used to facilitate proper alignment of the solder balls 80 on IC package 12 with the second ends 78 of the female sockets 46 of the second hermaphroditic terminal assembly 18 and the second ends of the male pins 34 of the second hermaphroditic terminal assembly 18. It is also appreciated that alignment elements are not required to properly align the electrical contacts 80 on IC package 12 with the second ends 78 of the female sockets 46 of the second hermaphroditic terminal assembly 18 and the second ends of the male pins 34 of the second hermaphroditic terminal assembly 18.

Hermaphroditic socket/adapter assembly 10 includes a hold-down cover 108 for securing the IC package 12 to the intercoupling component 19. Hold-down cover 108 includes a pair of opposite walls 110 having tab members 112 that engage the intercoupling component 19. Hold-down cover 108 includes a threaded thru-hole 114 that threadingly receives a heat sink 116 to provide a thermal path for dissipating heat from the IC package 12. Heat sink 116 is inserted through threaded thru-hole 114 and a slot 118 formed in the heat sink 116 facilitates threading the heat sink 116 within the cover, for example, with a screwdriver or coin. It is appreciated that other mechanisms may also be used to secure the IC package 12 to the intercoupling component 19. It is also appreciated that other heat sink arrangements may be substituted for the version shown in FIG. 1. In some applications, a heat sink may not be required. Therefore, it is appreciated that the hold-down cover 108 may be used to secure the IC package 12 to the intercoupling component 19 without a heat sink. It is also appreciated that the hold-down cover itself may not be necessary to secure the IC package 12 to the intercoupling component 19. In some applications, the IC package 12 may be soldered directly to the intercoupling component 19.

The second hermaphroditic terminal assembly 18 is coupled to the first hermaphroditic terminal assembly 16 by inserting each male pin 34 of the second terminal assembly 18 into a corresponding female socket 22 of the first hermaphroditic terminal assembly 16 and inserting each male pin 24 of the first hermaphroditic terminal assembly 16 into a corresponding female socket 46 of the second hermaphroditic terminal assembly 18. When the second hermaphroditic terminal assembly 18 is coupled to the first hermaphroditic terminal assembly 16, it is said to be mated with the first hermaphroditic terminal assembly 16. The alignment guide posts 92 disposed through the upper surface 72 of the insulating support member 68 of the second hermaphroditic terminal assembly 18 are inserted into alignment guide holes 58 in the upper surface 28 of the insulating support member 20 of the first hermaphroditic terminal assembly 16 and the alignment guide posts 52 disposed through the upper surface 28 of the first hermaphroditic terminal assembly 16 are inserted into alignment guide holes 98 in the upper surface 72 of the insulating support member 68 of the second hermaphroditic terminal assembly 18 to properly align the male pins 34 of the second hermaphroditic terminal assembly 18 with the corresponding female sockets 22 of the first hermaphroditic terminal assembly 16 and the male pins 24 of the first hermaphroditic terminal assembly 16 with the corresponding female sockets 46 of the second hermaphroditic terminal assembly 18. It is appreciated that other alignment elements could be used to facilitate proper alignment of the male pins 34 of the second hermaphroditic terminal assembly 18 with the corresponding female sockets 22 of the first hermaphroditic terminal assembly 16 and the male pins 24 of the first hermaphroditic terminal assembly 16 with the corresponding female sockets 46 of the second hermaphroditic terminal assembly 18. It is also appreciated that alignment elements are not required to properly align the male pins 34 of the second hermaphroditic terminal assembly 18 with the corresponding female sockets 22 of the first hermaphroditic terminal assembly 16 and the male pins 24 of the first hermaphroditic terminal assembly 16 with the corresponding female sockets 46 of the second hermaphroditic terminal assembly 18. In some applications, it may be advantageous for the alignment guide posts 92 disposed through the upper surface 72 of insulating support member 68 of the second hermaphroditic terminal assembly 18 and the alignment guide posts 52 disposed through the upper surface 28 of the first hermaphroditic terminal assembly 16 to serve as power, voltage, or ground connections.

Referring to FIG. 1, first hermaphroditic terminal assembly 16 is identical to second hermaphroditic terminal assembly 18. In order to connect first hermaphroditic terminal assembly 16 to second hermaphroditic terminal assembly 18, second hermaphroditic terminal assembly 18 is rotated 90 degrees so that the male pins 34 of the second hermaphroditic terminal assembly 18 are aligned with corresponding female sockets 22 of the first hermaphroditic terminal assembly 16 and the male pins 24 of the first hermaphroditic terminal assembly 16 are aligned with corresponding female sockets 46 of the second hermaphroditic terminal assembly 18. It is appreciated that the first hermaphroditic terminal assembly 16 need not be identical to the second hermaphroditic terminal assembly 18.

First hermaphroditic terminal assembly 16 is secured to PCB 14 such that the solder balls 38 attached to second ends 36 of the female sockets 22 of the first hermaphroditic terminal assembly 16 and the solder balls 38 attached to second ends 48 of the male pins 24 of the first hermaphroditic terminal assembly 16 are in contact with the electrical contacts 39 on PCB 14. The alignment guide posts 64 disposed through the lower surface 30 of the insulating support member 20 of the first hermaphroditic terminal assembly 16 are inserted into alignment guide holes 128 in PCB 14. It is appreciated that other alignment elements could be used to facilitate proper alignment of the solder balls 38 attached to second ends 36 of the female sockets 22 of the first hermaphroditic terminal assembly 16 and the solder balls 38 attached to second ends 48 of the male pins 24 of the first hermaphroditic terminal assembly 16 with the electrical contacts 39 on PCB 14. It is also appreciated that alignment elements are not required.

When IC package 12 is secured to the lower surface 74 of insulating support member 68 of the second hermaphroditic terminal assembly 18 such that the solder balls 80 on IC package 12 are in contact with the second ends 78 of the female sockets 46 of the second hermaphroditic terminal assembly 18 and the second ends 88 of the male pins 34 of the second hermaphroditic terminal assembly 18; second hermaphroditic terminal assembly 18 is coupled to the first hermaphroditic terminal assembly 16 such that each male pin 34 of the second hermaphroditic terminal assembly 18 is received within a corresponding female socket 22 of the first hermaphroditic terminal assembly 16 and each male pin 24 of the first hermaphroditic terminal assembly 16 is received within a corresponding female socket 46 of the second hermaphroditic terminal assembly 18; and first hermaphroditic terminal assembly 16 is secured to PCB 14 such that that the solder balls 38 attached to second ends 36 of the female sockets 22 of the first hermaphroditic terminal assembly 16 and the solder balls 38 attached to second ends 48 of the male pins 24 of the first terminal assembly 16 are in contact with the electrical contacts 39 on PCB 14, the IC package 12 being electrically connected to PCB 14.

FIGS. 2A and 2B illustrate the operation of intercoupling component 19. The solder balls 38 attached to second ends 36 of the female sockets 22 of the first hermaphroditic terminal assembly 16 and the solder balls 38 attached to second ends 48 of the male pins 24 of the first hermaphroditic terminal assembly 16 are in contact with the electrical contacts 39 on PCB 14. Similarly, the second ends 78 of the female sockets 46 of the second hermaphroditic terminal assembly 18 and the second ends 88 of the male pins 34 of the second hermaphroditic terminal assembly 18 are in contact with the solder balls 80 on IC package 12. Referring to FIG. 2A, IC package 12 and PCB 14 are not electrically connected. Referring to FIG. 2B, intercoupling component 19 is used to electrically connect IC package 12 and PCB 14. The electrical connection between IC package 12 and PCB 14 is formed by inserting each male pin 34 of the second hermaphroditic terminal assembly 18 into a corresponding female socket 22 of the first hermaphroditic terminal assembly 16 and inserting each male pin 24 of the first hermaphroditic terminal assembly 16 into a corresponding female socket 46 of the second hermaphroditic terminal assembly 18.

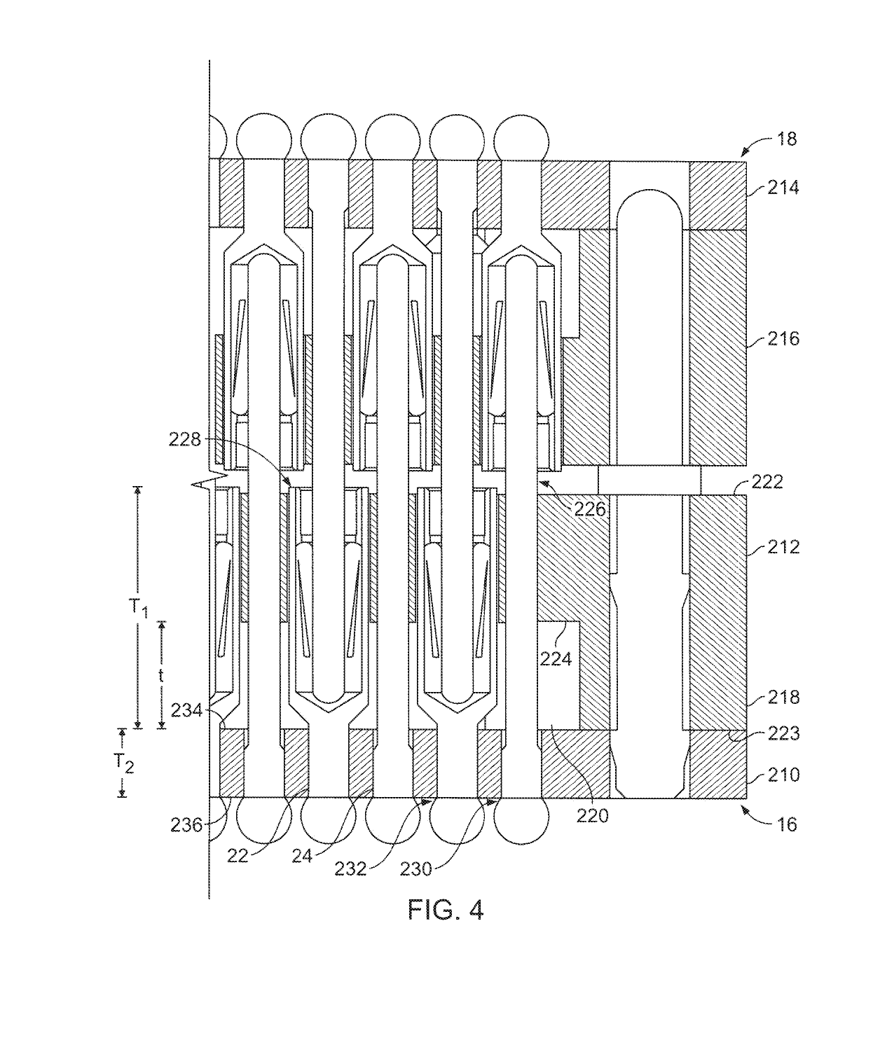

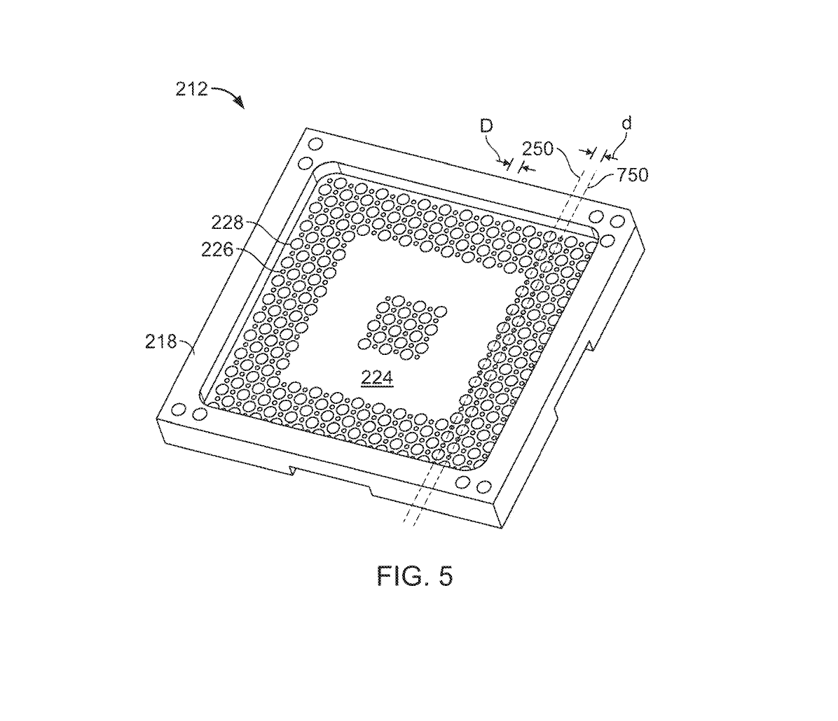

Other embodiments of a hermaphroditic socket adapter assembly may be configured in a manner that provides improved electrical characteristics (e.g., improved capacitance, impedance, and electromagnetic coupling characteristics). For example, referring to FIGS. 4 and 5, terminal assemblies 16, 18 have a first insulating support member 212, 216 that include a peripheral wall 218 that defines an interior recess 220. First insulating support member 212 also includes a first array of apertures 228, each aperture extending from an upper surface 222 of the first insulating support member to an opposite lower surface 224 of the first insulating support member contiguous with recess 220, each aperture 228 configured to receive socket 22. First insulating support member 212 also includes a second array of apertures 226, each aperture extending from upper surface 222 of the first insulating support member to opposite lower surface 224 of the first insulating support member contiguous with recess 220, each aperture 226 configured to receive pin 24. Sockets 22 and pins 24 as described above can be used. In some instances, first insulating support member 212 can have a thickness T₁ between about 0.020 and 1.0 inch (e.g., between about 0.050 and 0.100 inch; or between about 0.070 and 0.080 inch) and recess 220 can have a depth t between about 0.010 and 0.980 inch (e.g., between about 0.025 and 0.050 inch; or between about 0.030 and 0.040 inch).

Terminal assemblies 16, 18 also include a second insulating support member 210, 214. Second insulating support members 210, 214 include a third array of apertures 232 corresponding to first array of apertures 228, each aperture extending from an upper surface 234 of the second insulating support member to an opposite lower surface 236 of the second insulating support member, each aperture configured to receive a socket 22. Second insulating support members 210, 214 also include a fourth array of apertures 230 corresponding to the second array of apertures 226, each aperture extending from upper surface 234 of the second insulating support member to opposite lower surface 236 of the second insulating support member, each aperture 230 configured to receive a pin 24. Second insulating support member 210 can have a thickness T₂ between about 0.001 and 0.050 inch (e.g., between about 0.015 and 0.025 inch).

The fact that only air separates adjacent sockets 22 and pins 22 in recess 220 can provide the designed of such terminal assemblies with the ability to adjust the electrical characteristics relative to terminal assemblies without such recesses 20. For example, the dimensions of recess 220 can optimized or otherwise adjusted to produced terminal assemblies with specific desired electrical characteristics (e.g., capacitance, impedance, and electromagnetic coupling characteristics).

In some instances, first insulating support member 212 can be produced by machining the first and second arrays of apertures 226, 228 in a first support member with each aperture extending from a first surface 222 of the first support member and terminating before reaching an opposite second surface 223 of the first support member. A recess 220 can then be formed by, for example, machining or counter-boring in opposite second surface 223 of the first support member such that each aperture 226, 228 extends from first surface 222 of the first support member to a base surface 224 of the recess. A second insulating support member 210 can then be attached to first insulating support member 212 with apertures 230, 232 corresponding to and aligned with apertures 226, 228. Sockets 22 and pins 24 can be press fit within the apertures. In some instances, machining apertures 226, 228 only partway through first insulating support member 212 provides increased ease of machining and improved true positioning of the apertures relative to methods of manufacturing in which apertures 226, 228 are machined through the full thickness of an insulating support member. The advantage of this approach increases with the increasing thickness of the insulating support member to which it is applied.

Referring to FIGS. 1-5, arrays of socket-receiving apertures 26, 70, 228, 232 and arrays of pin receiving apertures 42, 84, 226, 230 can be arranged in a pattern comprising a plurality of columns with each column having an axis 250. The columns located such that the distance d between the axes of adjacent columns is less than a standard diameter D of socket-receiving apertures 26, 70, 228, 232. This arrangement can provide for reduced spacing between adjacent pin/socket pairs.

In certain applications it may be desired to space the hermaphroditic terminal assemblies 16, 18 from each other, for example, if there are printed circuit board limitations such that the upper hermaphroditic terminal assembly 18 is desired to be higher than other portions of the printed circuit board 14.

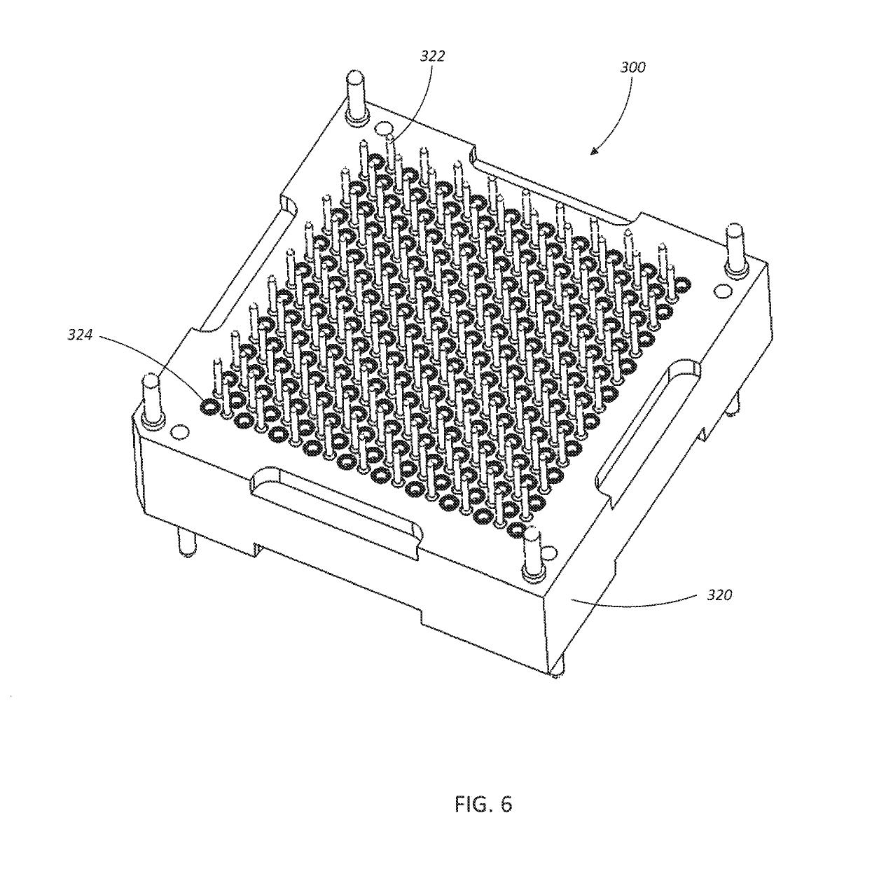

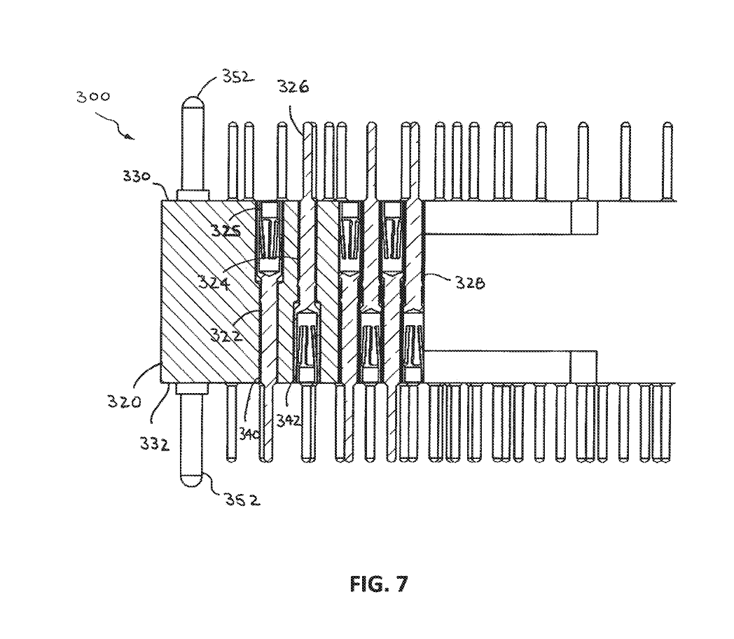

Referring to FIGS. 6-8, a hermaphroditic spacer connector 300 includes an insulating support member 320 for supporting an array of terminals 322, 324.

In this embodiment, terminals 322 are identical to terminals 324 but are inverted relative to each other. Both of terminals 322, 324 include an end having a female socket 325 configured to receive male pin 24, for example, of hermaphroditic terminal assemblies 16, 18. The opposite end of terminals 322, 324 also include a male pin 326 that is configured to be received within sockets 22, for example, of hermaphroditic terminal assemblies 16, 18. The ends of terminals 322, 324 are separated by a barrel section 328.

Terminals 322 are positioned in a first array of apertures 340 extending from an upper surface 330 of insulating support member 320 to the bottom surface 332 of insulating support member 320. In inverted fashion, terminals 324 are positioned a second array of apertures 342, extending from the upper surface 330 of insulating support member 320 to the bottom surface 332 of insulating support member 320.

The first array of apertures 340 and second array of apertures are both configured to have a first diameter for accommodating the larger end of terminals 322, 324 and a second diameter, smaller than the first diameter, for accommodating the smaller end of terminals 322, 324. That is, the first and second diameters are sized and shaped commensurate with female sockets 325 and male pins 326, respectively.

As was the case with hermaphroditic terminal assemblies 16, 18, it may be desirable for at least one of the male pins 326 of the terminals 322, 324 to be of a different height than every other male pin of terminals 326 where the height of a pin is defined as the length from the first end of the pin to the second end of the pin. Similarly, it may be desirable for at least one of the male pins of the terminals 322, 324 to be of a different height than every other male pin of terminals 322, 324.

As was also the case with hermaphroditic terminal assemblies 16, 18, terminals 322, 324 are received within the first and second array of apertures 340, 342 of the insulating support member 320 are arranged such that interstitial spaces exist between the male pins 326. Collectively, terminals 322, 324 are arranged in a pattern such that the interstitial spaces between the female sockets 325 of terminal 322 are occupied by male pins 326 of terminal 324, and the interstitial spaces between the male pins 326 of terminal 322 are occupied by female sockets 325 of terminal 324.

As was the case with a hermaphroditic spacer connector 300 also includes alignment guide posts 352 located on both upper surface 328 and bottom surface 330 and in corners of insulating support member 320 to align with first and second hermaphroditic terminal assemblies 16, 18.

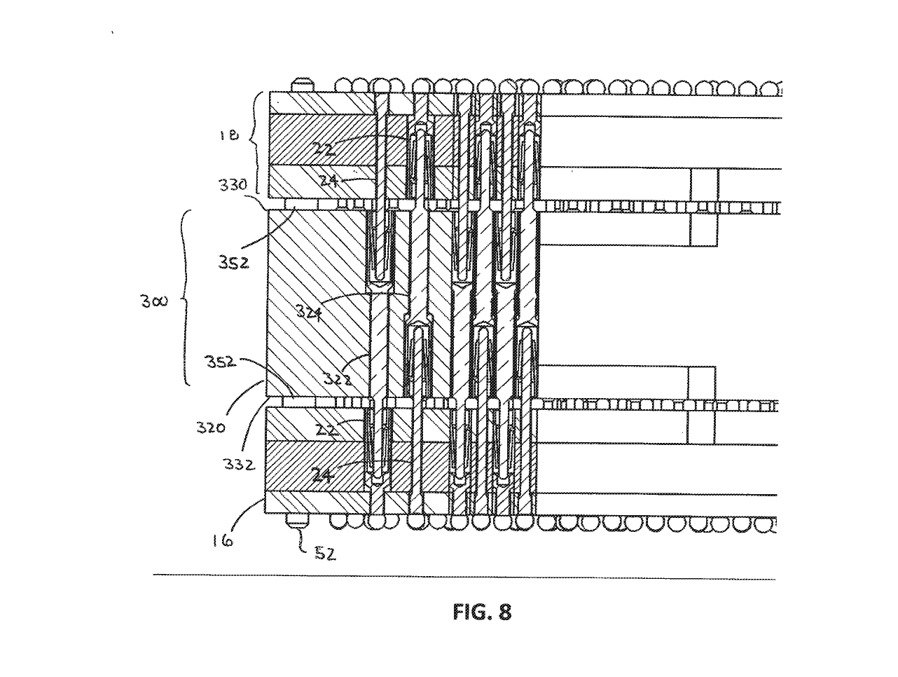

Referring to FIG. 8, hermaphroditic spacer connector 300 is shown positioned between hermaphroditic terminal assemblies 16, 18. As was described in more detail above, hermaphroditic terminal assemblies 16, 18 include female sockets 22 and male pins 24 having solder balls 38 for establishing electrical connections to, for example, a printed circuit board 14.

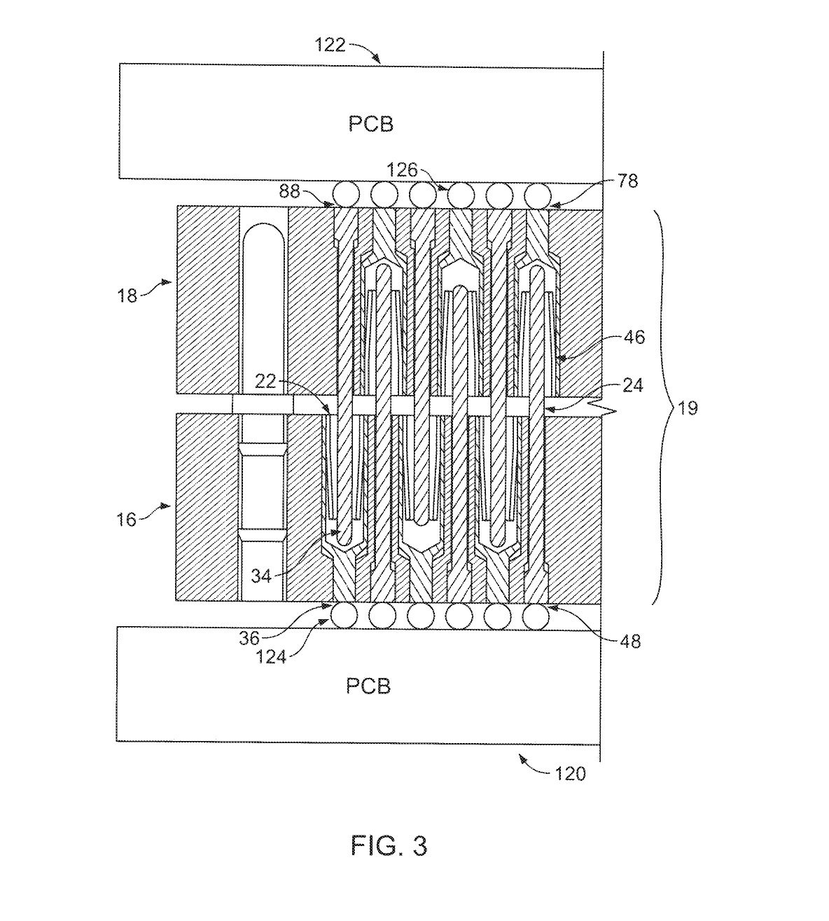

A number of embodiments of the invention have been described. Nevertheless, it will be understood that various modifications may be made without departing from the spirit and scope of the invention. For example, hermaphroditic terminal assemblies can be used to electrically connect many different types of electrical devices. Referring to FIG. 3, intercoupling component 19, including first hermaphroditic terminal assembly 16 and second hermaphroditic terminal assembly 18, are used to electrically connect a first PCB 120 to a second PCB 122. The second ends 36 of the female sockets 22 of the first hermaphroditic terminal assembly 16 and the second ends 48 of the male pins 24 of the first hermaphroditic terminal assembly 16 are connected to solder balls 124 and form an electrical connection with the electrical contacts 125 on first PCB 120. Similarly, the second ends 78 of the female sockets 46 of the second hermaphroditic terminal assembly 18 and the second ends 88 of the male pins 34 of the second hermaphroditic terminal assembly 18 are connected to solder balls 126 and form an electrical connection with the electrical contacts 127 on second PCB 122. The electrical connection between first PCB 120 and second PCB 122 is formed by inserting each male pin 34 of the second hermaphroditic terminal assembly 18 into a corresponding female socket 22 of the first hermaphroditic terminal assembly 16 and inserting each male pin 24 of the first hermaphroditic terminal assembly 16 into a corresponding female socket 46 of the second hermaphroditic terminal assembly 18. Accordingly, other embodiments are within the scope of the following claims.

What is claimed is:

1. A terminal assembly of the type used to electrically connect electrical devices, the terminal assembly comprising:
an insulating support member including
a first array of apertures and a second array of apertures, each aperture of the first and second array of apertures extending from an upper surface of the first insulating support member to an opposite lower surface of the insulating support member; and
a first plurality of terminals for providing electrical connections arranged in a configuration corresponding with the first array of apertures, each of the first plurality of terminals received within a corresponding aperture of the first array of apertures of the insulating support member and having an end with an opening and an opposite end configured to contact a corresponding electrical contact; and
a second plurality of terminals for providing electrical connections arranged in a configuration corresponding with the second array of apertures, each of the second plurality of terminals received within a corresponding aperture of the second array of apertures of the insulating support member and having an end configured to be received within a socket and an opposite end configured to contact a corresponding electrical contact.

2. The terminal assembly of claim 1 wherein the opposite end of each of the first plurality of terminals is a pin.

3. The terminal assembly of claim 1 wherein the opposite end of each of the second plurality of terminals is a socket.

4. The terminal assembly of claim 1 wherein the opposite end of each of the first plurality of terminals is a pin and the opposite end of each of the second plurality of terminals is a socket.

5. The terminal assembly of claim 1 wherein the terminal assembly further comprises
a plurality of interstitial spaces between the first plurality of terminals;
a plurality of interstitial spaces between the second plurality of terminals;
and wherein the first plurality of terminals and the second plurality of terminals are arranged in a pattern comprising a plurality of columns, each column arranged in an alternating sequence of first plurality of terminals and second plurality of terminals such that each interstitial space between the first plurality of terminals is occupied by one of the second plurality of terminals and each interstitial space between the second plurality of terminals pins is occupied by one of the first plurality of terminals.

6. The terminal assembly of claim 5 wherein the pattern includes a plurality of rows, each row arranged in an alternating sequence of first plurality of terminals and second plurality of terminals such that each interstitial space between the first plurality of terminals is occupied by one of the second plurality of terminals and each interstitial space between the second plurality of terminals pins is occupied by one of the first plurality of terminals.

7. The terminal assembly of claim 1 wherein the first array of apertures and the second array of apertures are arranged in a pattern comprising a plurality of columns, each column having an axis, the columns located such that the distance between the axes of adjacent columns is less than a standard diameter of apertures of the first array of apertures.

8. The terminal assembly of claim 7 wherein each column is arranged in an alternating sequence of the first plurality of terminals and the second plurality of terminals.

9. The terminal assembly of claim 4 wherein the height of at least one pin of the plurality of pins is different than the height of every other pin.

10. The terminal assembly of claim 1 wherein the insulating support member includes at least one alignment element.
to align the first plurality of terminals and second plurality of terminals with corresponding electrical contacts on a corresponding terminal assembly.

11. The terminal assembly of claim 10 wherein the at least one alignment element comprises at least one alignment guide post disposed through the insulating support member to be received by a corresponding alignment hole in a corresponding terminal assembly.

12. The terminal assembly of claim 10 wherein the at least one guide post provides an electrical connection.

13. A method of manufacturing a terminal assembly of the type used to electrically connect electrical devices, the method comprising:
providing a first insulating support member including a first array of apertures and a second array of apertures, each aperture of the first and second array of apertures extending from an upper surface of the first insulating support member to an opposite lower surface of the insulating support member;
positioning a first plurality of terminals for providing electrical connections within a corresponding aperture of the first array of apertures of the insulating support member and having an end with an opening and an opposite end configured to contact a corresponding electrical contact; and
positioning a second plurality of within a corresponding aperture of the second array of apertures of the insulating support member and having an end configured to be received within a socket and an opposite end configured to contact a corresponding electrical contact.

14. The method of manufacturing a terminal assembly of claim 13 wherein
providing the first insulating support member comprises:
machining the first and second arrays of apertures in the first support member, each aperture extending from a first surface of the first support member and terminating before reaching an opposite second surface of the first support member;
forming a recess in the opposite second surface of the first support member such that each aperture extends from the first surface of the first support member to a base surface of the recess.

15. The method of manufacturing a terminal assembly of claim 13 wherein
the first plurality of terminals defines a first plurality of interstitial spaces between the first plurality of terminals;
the second plurality of terminals defines a second plurality of interstitial spaces between the second plurality of terminals; and
arranging the first plurality of terminals and the second plurality of terminals in a pattern comprising a plurality of columns, each column arranged in an alternating sequence of the first plurality of terminals and the second plurality of terminals such that each interstitial space between the first plurality of terminals is occupied by one of the first plurality of terminals pin and each interstitial space between the second plurality of terminals pins is occupied by one of the second plurality of terminals.
